(19) United States
(12) Patent Application Publication
(10) Pub. No.: US 2019/0191206 A1
(43) Pub. Date: Jun. 20, 2019

(54) METHOD AND SYSTEM OF GENERATING A USER INFLUENCED RECOMMENDATION LIST

(71) Applicant: Dura Operating, LLC, Auburn Hills, MI (US)

(72) Inventors: Aaron Brion Stachewicz, Troy, MI (US); Patricia Machado, Detroit, MI (US); Rui De Oliveira, Detroit, MI (US); Cumhur Unveren, Walled Lake, MI (US)

(21) Appl. No.: 15/848,792

(22) Filed: Dec. 20, 2017

(51) Int. Cl. H04N 21/414; H04N 21/45; G06F 17/30; G01C 21/34

(52) U.S. Cl. CPC H04N 21/41422; H04N 21/4532; G06F 17/30991; G06F 17/30769; G01C 21/3484; G06F 17/30761

(57) ABSTRACT

A method of generating a user influenced recommendation list is provided. The method includes the steps of detecting a first user device and detecting a second user device within a predetermined zone within a compartment of the vehicle; coupling the first user device and the second user device to a recommendation engine; uploading a first preference list of contents from the first user device and a second preference list of contents from the second user device to the recommendation engine; selecting a ratio of contents from the first preference list and second preference list; and generating a third preference list of recommended contents, by the recommendation engine, by analyzing the selected ratio of contents from the first and second preference lists. The ratio is selected via a GUI. A system is provided for the implementation of the method.

### FIELD

The invention relates generally to a method and system of generating a list of recommended content, more particularly, a method and system of generating a user influenced recommendation list.

### BACKGROUND

The statements in this section merely provide background information related to the present disclosure and may or may not constitute prior art.

Recommendation lists of contents for a specific content user are commonly generated by service providers for the recommendation of consumer contents such as songs, movies, consumer products, restaurants, etc. Service providers use recommendation engines to generate recommendation lists based on: a particular artist or genre, when the contents were last accessed, the frequency of access to the contents, and/or random selection of previously accessed contents. Service providers also use recommendation engines based on proprietary methods for generating recommendation lists based on a user's historical usage of the contents.

The conventional methods for generating a recommendation list does not take into account the preferences of multiple content users. The qualities that make a recommendation list interesting to a particular user may not be interesting for another particular user. This is especially true in media content, such as music content, shared in a vehicle between two or more passengers. Thus, while current recommendation engines achieve their intended purpose, there is a need for a new and improved method and system for generating a preference list based on the preferences of multiple users.

### SUMMARY

According to several aspects, a method of generating a user influenced recommendation list is disclosed herein. The method includes the steps of coupling a first user device and a second user device to a recommendation engine; uploading a first preference list of contents from the first user device to the recommendation engine; uploading a second preference list of contents from the second user device to the recommendation engine; and generating a third preference list of recommended contents by analyzing a user selected ratio of the contents from the first and second preference lists. The contents from the first and second preference lists may include, but not limited to media files such as music and movies; navigation data; favorite lists including favorite places, restaurants, artist; and recommendation lists.

In an additional aspect of the present disclosure, the user selected ratio of contents from the first and second preference list is selected by the user by sliding a lever along a continuum of ratios.

In another aspect of the present disclosure, the continuum is displayed on a Graphic User Interface (GUI), and the lever is a graphical pointer slideable between a first end of the continuum and a second end of the continuum.

In another aspect of the present disclosure, a first end of the continuum represents 100 percent of contents from the first preference list and 0 percent of contents form the second preference list, and a second end of the continuum represents 0 percent of content from the first preference list and 100 percent of contents from the second preference list.

In another aspect of the present disclosure, the first, second, and third preference lists are displayed on the GUI. The contents in each of the first, second, and third preference lists are selectable by the user.

In another aspect of the present disclosure, the step of generating the third preference list of recommended contents further includes combining the first and second preference list, and removing redundant contents.

In another aspect of the present disclosure, the step of generating the third preference list of recommended contents further includes generating at least one recommended content.

In another aspect of the present disclosure, the step of generating the third preference list of recommended contents further includes adding the least one recommended content into the combined first and second preference lists.

In another aspect of the present disclosure, the step of generating the third preference list of recommended contents further includes, filtering the combined contents into genres; identifying a first group of genres having contents originated solely from the first preference list; identifying a second group of genres having contents originated solely from the second preference list; identifying a third group of genres having contents originated from both the first and second preference list, and the recommended content; and displaying the combined preference list in a spectrum, wherein the first group of genres is displayed adjacent one end of the spectrum, the second group of genres is displayed adjacent the opposite end of the spectrum, and the third group of genres is displayed adjacent the center of the spectrum.

In another aspect of the present disclosure, the method further includes the steps of determining whether the first user device and second user device are both within a predetermined zone, and enabling user access to a Human Machine Interface (HMI) located within the predetermined zone. The HMI is configured to enable the user to select the ratio of the contents from the first and second preference list.

According to several aspects, a method of generating a user influenced recommendation list displayable on a graphic user interface (GUI) in a vehicle is disclosed. The method includes the steps of detecting a first user device and detecting a second user device within a predetermined zone within a compartment of the vehicle; coupling the first user device and the second user device to a recommendation engine; uploading a first preference list of contents from the first user device and a second preference list of contents from the second user device to the recommendation engine; selecting a ratio of contents from the first preference list and second preference list; generating a third preference list of recommended contents, by the recommendation engine, by analyzing the selected ratio of contents from the first and second preference lists; and displaying the third preference list on the GUI located within the predetermined zone.

In an additional aspect of the present disclosure, the recommendation engine is located remote from the vehicle.

In another aspect of the present disclosure, the GUI is located on one of the first user or second user devices.

In another aspect of the present disclosure, the ratio input of media contents from the first and second preference lists is selectable by a user by sliding a lever along a continuum on the GUI.

In another aspect of the present disclosure, the step of analyzing the selected ratio of contents includes identifying contents that are within a common genre in the first and second preference lists. The method further includes the step of generating the third preference list based on the common genre.

According to several aspects, a system for generating a user influenced recommendation list is disclosed. The system includes a receiver configured to receive an upload of a plurality of preference lists from a plurality of user devices; a human machine interface (HMI) configured to receive a user selected ratio of the contents from the first and second preference lists; and a recommendation engine in communication with the receiver and HMI. The recommendation engine is configured to generate a third preference list of recommended contents by analyzing the user selected ratio of the contents from the first and second preference lists.

In an additional aspect of the present disclosure, the HMI is a graphic user interface (GUI) configured to display a continuum having a pointer slideable between a first end of the continuum and a second end of the continuum. The first end represents a 100 percent ratio of contents from a first user device and the second end represents a 100 percent ratio of contents from the second user device.

In another aspect of the present disclosure, the recommendation engine is further configured to determine whether the first user device and the second user device are both within a predetermined zone within a vehicle; and enable user access to the GUI if the first user device and the second user device are both within the predetermine zone.

In another aspect of the present disclosure, the GUI is located on one of the user devices.

In another aspect of the present disclosure, the recommendation engine is located remote from the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a system for generating a user influenced recommendation list, according to an exemplary embodiment;

FIG. 2 is an illustration of a top view of a passenger compartment of a vehicle having the system of generating a user influenced recommendation list of FIG. 1, according to an exemplary embodiment;

FIG. 3 is a block flow diagram showing a method of generating a user influenced recommendation list, according to an exemplary embodiment;

FIG. 4 is an illustration of a user influenced recommendation list generated by the system of FIG. 1, according to an exemplary embodiment; and

FIG. 5 is an illustration of a control panel display for generating a user influenced recommendation list, according to an exemplary embodiment.

### DETAILED DESCRIPTION

The following description is merely exemplary in nature and is not intended to limit the present disclosure, application, or uses.

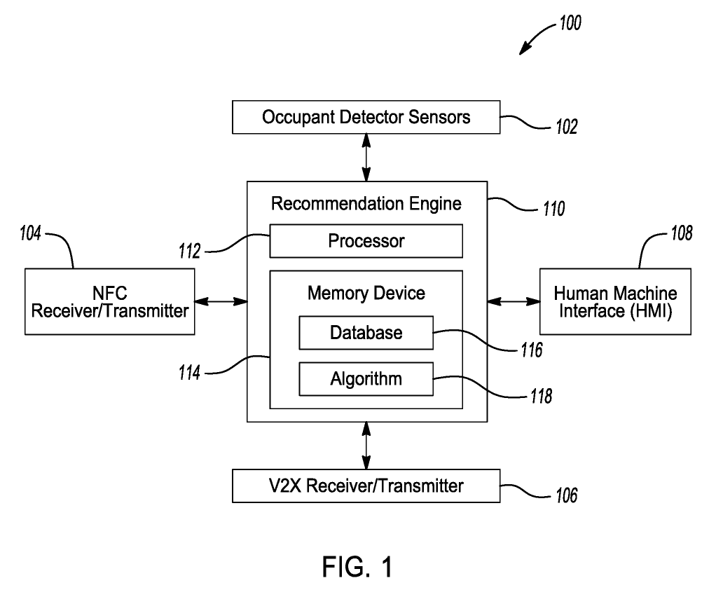

FIG. 1 shows a schematic of a system 100 for generating a user influenced recommendation list for a vehicle. The system 100 includes occupant detection sensors 102, near field communication (NFC) receivers/transmitters 104, vehicle-to-everything (V2X) receivers/transmitters 106, and a human machine interface (HMI) 108, all of which are in electronic communications with a recommendation engine 110.

The occupant detection sensors 102 are configured to detect whether there is an occupant in the vehicle. The occupant detection sensors 102 may include infrared sensors, motion sensors, range sensors, pressure sensors, image sensors, or pressure sensors. The occupant sensors 102 are placed in strategic locations within the passenger compartment of the vehicle such that the location of a detected occupant can be determined. For example, a pressure sensor or motion sensor may be placed adjacent a seating area to detect whether that particular seating area is occupied. Each of the occupant detection sensors 102 may include dedicated application-specific integrated circuit (ASIC) for detecting and locating an occupant within the vehicle. Alternatively, the occupant detection sensors 102 may send a signal containing information gathered by the occupant detection sensors 102 to a vehicle controller (not shown) for processing to detect and locate the occupant.

The NFC receiver/transmitters 104 are configured to communicate with personal electronic devices in the possession of the occupants within the vehicle. The personal electronic devices may include smart phones, tablets, computers, key fobs, NFC enable cards, and/or any other electronic devices capable of utilizing NFC. The NFC receivers/transmitters 104 are placed in strategic locations within the vehicle to determine the locations of the electronic devices within the passenger compartment. The NFC receivers/transmitters 104 are further configured to upload user content and/or user preference lists from the personal electronic device to the recommendation engine 110.

The HMI 108 may include mechanical knobs, dials, and/or levers located within the vehicle as part of the infotainment system. The HMI 108 may be that of a display monitor configured to display the preference list uploaded from the individual user devices and/or the recommendation list, also known as a preference list, generated by the recommendation engine 110. It is preferable that the HMI is a graphic user interface (GUI) configured to allow the users to interact with the recommendation engine 110 through graphical icons and visual indicators. The GUI may be displayed on a touch screen display such as a resistive, capacitive, surface acoustic wave, infrared, and/or optical imaging touchscreen.

The recommendation engine 110 may be located on board the vehicle or remote from the vehicle. If the recommendation engine 110 is remote from the vehicle, information obtained by the NFC receiver/transmitters 104 may be communicated to the remote recommendation engine 110 by using the vehicle-to-everything (V2X) receiver/transmitters 106 located on the vehicle. It is understood that that V2X receivers/transmitters 106 include vehicle-to-vehicle (V2V) and vehicle-to-infrastructure communication (V2I) systems.

The recommendation engine 110 includes a processor 112 and a memory device 114. The processor 112 may be any conventional processor, such as commercially available CPUs or other hardware-based processor. The memory device 114 includes a database 116 and stored algorithms 118 for generating a recommendation list based on at least two separate preference lists. The database 116 and algorithms 118 are accessible by the processor 112. The memory device 114 may be any computing device readable medium such as hard-drives, solid state memory, ROM, RAM, DVD or any other medium that is capable of storing information that is accessible by the processor 112.

Although only one recommendation engine 110 is shown, it is understood that the vehicle may contain multiple recommendation engines 110. Each of the recommendation engines 110 may include more than one processor and memory, and the plurality of processors and memories do not necessary have to be housed within the respective controllers. Accordingly, references to a recommendation engine, processor, and memory devices include references to a collection of such recommendation engines, processors, and memory devices that may or may not operate in parallel.

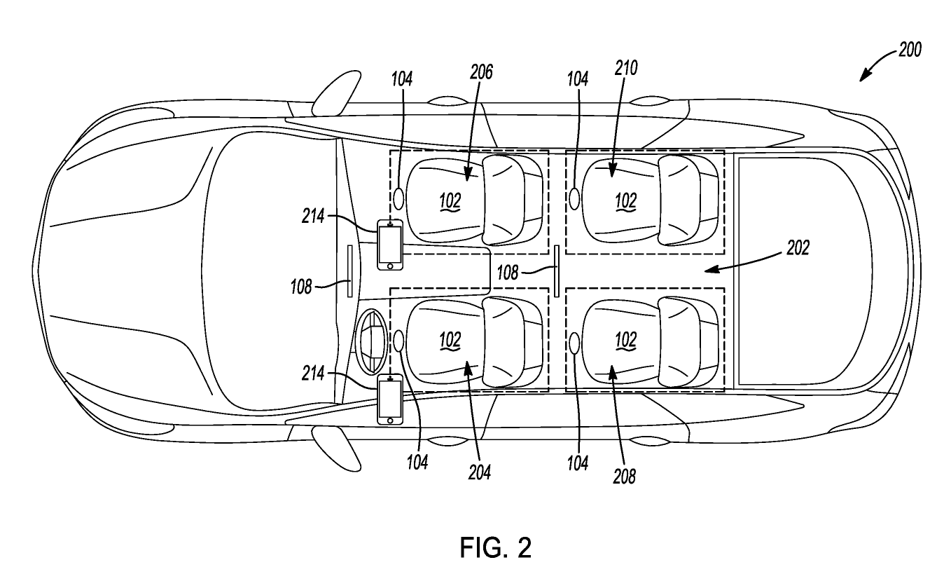

FIG. 2 is a top view of an exemplary vehicle 200 showing a cutaway view of the passenger compartment 202. Adjacent a forward section of the passenger compartment 202 is a driver seating area 204 and an adjacent passenger seating area 206. A third passenger seating area 208 and an adjacent fourth passenger seating area 210 are located immediately behind the driver seating area 204 and the passenger seating area 206, respectively. The seating areas 204, 206, 208, 210 may each have an occupant detection sensor 102, such as a pressure sensor 102, to detect whether the seating areas 204, 206, 208, 210 are occupied. Located adjacent each of the seating areas 204, 206, 208, 210 is a NFC transmitter/receiver 104. The NFC transmitter/receivers are configured to detect and communicate with an electronic personal device located within the respective seating areas 204, 206, 208, 210. Provided between adjacent seating areas is a HMI 108, such as a GUI.

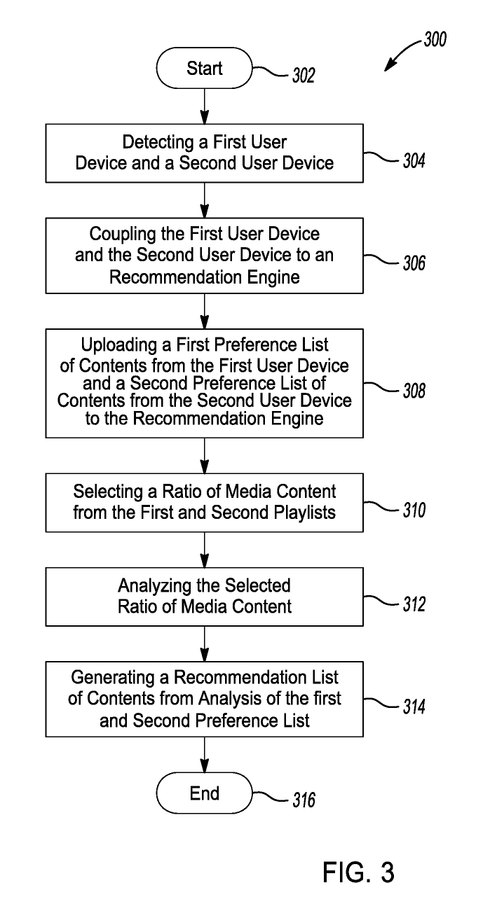

FIG. 3 is a block flow diagram of a method for generating a user influenced recommendation list 300, also known as a user influenced preference list 300. The method starts at block 302. In block 304, a first and second user devices are detected within the passenger compartment of the vehicle. A determination is made as to whether the first user device and second user device are both within a predetermined zone, such as adjacent seating areas. If the first and second user devices are within the same predetermined zone, then the access to a Human Machine Interface (HMI) within the predetermined zone is enabled.

In block 306, the first and second user devices are coupled to a recommendation engine, which may be part of the infotainment system or located remote from the vehicle on a site or cloud server. In block 308, a first preference list of contents from the first user device and a second preference list of contents from the second user device are uploaded to the recommendation engine.

In block 310, a user selects a ratio of contents from the first and second preference list. The HMI is configured to enable the user to select a ratio of the contents from the first and second preference list. For example, if a ratio of 20/80 is selected, then 20 percent of content is selected from the first preference list and 80 percent of content is selected from the second preference list. The ratio may be selected by sliding a lever along a continuum of ratios. The lever may be an actual hardware lever or a graphical representation of a lever using a graphic user interface (GUI) as part of the infotainment system. The continuum may be displayed on the GUI and the lever may be represented by graphical pointer slideable between a first end of the continuum and a second end of the continuum.

In block 312, the uploaded first and second preference lists of contents are analyzed in accordance with the ratio selected by the user. The contents may be analyzed by first combining the first and second preference lists and removing redundant contents. Then followed by filtering the combined contents into genres, identifying a first group of genres having contents originated solely from the first preference list, identifying a second group of genres having contents originated solely from the second preference list, and identifying a third group of genres having contents originated from both the first and second preference list.

In block 314, a third preference list of recommended contents is generated by analyzing the identified first, second, and third groups of genres to generate recommended contents. The routine for the analysis of the groups of genres may reside in the recommendation engine or provided by a service provider. The third preference list is displayed on a spectrum on the GUI. The first group of genres is displayed adjacent one end of the spectrum, the second group of genres is displayed adjacent the opposite end of the spectrum, and the third group of genres together with the generated recommended contents is displayed adjacent the center of the spectrum. The method ends in block 316.

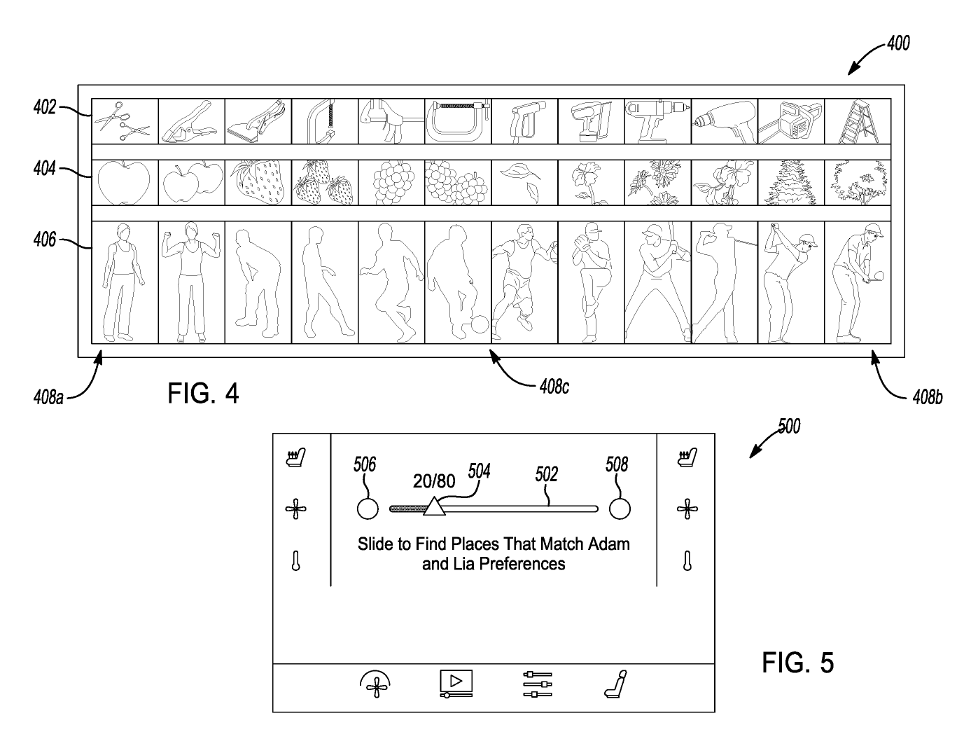

FIG. 4 is an exemplary depiction 400 of a user influenced recommendation list generated by the system of FIG. 1. FIG. 4 shows a first preference list of contents 402 from the first user device and a second preference list of contents from the second user device. The individual contents from the first and second preference lists 402, 404 are displayed on a GUI as thumbnails on a scrollable continuum for each of the respected first and second preference lists 402, 404. The recommendation engine generated recommendation list 406, or third preference list 406, is shown beneath the first and second preference lists 402, 404. The individual contents from the recommendation lists 406 are displayed as thumbnails on a scrollable continuum in a spectrum 408. The contents from the first preference lists 402 are displayed adjacent one end of the spectrum 408a, the contents from the second preference lists 404 are displayed adjacent the opposite end of the spectrum 408b, and the content common to both the first and second preference lists are displayed adjacent the center of the spectrum 408c.

FIG. 5 is an illustration of a control panel display 500 on a GUI for generating the user influenced recommendation list, according to an exemplary embodiment. The display includes a continuum 502 having a pointer 504 slideable between a first end of the continuum 506 and a second end of the continuum 508. The first end represents a 100 percent ratio of contents from a first user device 214a and the second end represents a 100 percent ratio of contents from the second user device 214b. A user slides the pointer 504 along the continuum 506 for selecting a ratio of contents from the first preference list and second preference list. Recommended contents are generated, by the recommendation engine, by analyzing the selected ratio of contents from the first and second preference lists.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. A method of generating a user influenced recommendation list, comprising the steps of:
coupling a first user device and a second user device to a recommendation engine;
uploading a first preference list of contents from the first user device to the recommendation engine;
uploading a second preference list of contents from the second user device to the recommendation engine; and
generating a third preference list of recommended contents by analyzing a user selected ratio of the contents from the first and second preference lists.

2. The method of claim 1, wherein the user selected ratio of the contents from the first and second preference list is selected by the user by sliding a lever along a continuum of ratios.

3. The method of claim 2, wherein the continuum of ratios is displayed on a Graphic User Interface (GUI), and the lever is a graphical pointer slideable between a first end of the continuum and a second end of the continuum.

4. The method of claim 3, wherein a first end of the continuum represents 100 percent of contents from the first preference list and 0 percent of contents form the second preference list, and
wherein a second end of the continuum represents 0 percent of content from the first preference list and 100 percent of contents from the second preference list.

5. The method of claim 4, wherein the first, second, and third preference lists are displayed on the GUI; wherein the contents in each of the first, second, and third preference lists are selectable by the user.

6. The method of claim 1, wherein the step of generating the third preference list of recommended contents further includes combining the first and second preference list, and removing redundant contents.

7. The method of claim 6, wherein the step of generating the third preference list of recommended contents further includes generating at least one recommended content.

8. The method of claim 7, wherein the step of generating the third preference list of recommended contents further includes adding the least one recommended content into the combined first and second preference lists.

9. The method of claim 8, wherein the step of generating the third preference list of recommended contents further includes:
filtering the combined contents into genres;
identifying a first group of genres having contents originated solely from the first preference list;
identifying a second group of genres having contents originated solely from the second preference list;
identifying a third group of genres having contents originated from both the first and second preference list, and the recommended content; and
displaying the combined preference list in a spectrum, wherein the first group of genres is displayed adjacent a first end of the spectrum, the second group of genres is displayed adjacent a second end of the spectrum opposite the first end of the spectrum, and the third group of genres is displayed adjacent a center portion of the spectrum.

10. The method of claim 1, further comprising the steps of:
determining whether the first user device and second user device are both within a predetermined zone; and
enabling a user access to a Human Machine Interface (HMI) located within the predetermined zone, wherein the HMI is configured to enable the user to select the ratio of the contents from the first and second preference list.

11. A method of generating a user influenced recommendation list displayable on a graphic user interface (GUI) in a vehicle, comprising the steps of:
detecting a first user device and detecting a second user device within a predetermined zone within a compartment of the vehicle;
coupling the first user device and the second user device to a recommendation engine;
uploading a first preference list of contents from the first user device and a second preference list of contents from the second user device to the recommendation engine;
selecting a ratio of contents from the first preference list and second preference list;
generating a third preference list of recommended contents, by the recommendation engine, by analyzing the selected ratio of contents from the first and second preference lists; and
displaying the third preference list on the GUI.

12. The method of claim 11, wherein the recommendation engine is located remote from the vehicle.

13. The method of claim 11, wherein the GUI is located on one of the first user or second user devices.

14. The method of claim 11, wherein the ratio of contents from the first and second preference lists is selectable by a user by sliding a lever along a continuum on the GUI.

15. The method of claim 14, wherein analyzing the selected ratio of contents includes identifying contents that are within a common genre in the first and second preference lists, and further includes the step of generating the third preference list based on the common genre.

16. A system for generating a user influenced recommendation list, comprising:
a receiver configured to receive an upload of a plurality of preference lists from a plurality of user devices;
a human machine interface (HMI) configured to receive a user selected ratio of the contents from the first and second preference lists; and
a recommendation engine in communication with the receiver and HMI, wherein the recommendation engine is configured to generate a third preference list of recommended contents by analyzing the user selected ratio of the contents from the first and second preference lists.

17. The system of claim 16, wherein the HMI is a graphic user interface (GUI) configured to display a continuum having a pointer slideable between a first end of the continuum and a second end of the continuum, wherein the first end represents a 100 percent ratio of contents from a first user device and the second end represents a 100 percent ratio of contents from the second user device.

18. The system of claim 17, wherein the recommendation engine is further configured to determine whether the first user device and the second user device are both within a predetermined zone within a vehicle; and enable user access to the GUI if the first user device and the second user device are both within the predetermine zone.

19. The system of claim 18, wherein the GUI is located on one of the first and second user devices.

20. The system of claim 19, wherein the recommendation engine is located remote from the vehicle.
